(19) United States
(12) Patent Application Publication
(10) Pub. No.: US 2025/0141527 A1
(43) Pub. Date: May 1, 2025

(54) METHOD AND APPARATUS FOR ALLOCATING SUBARRAYS ON BASIS OF DIRECTION INFORMATION AND/OR DISTANCE INFORMATION ABOUT USER

(71) Applicant: LG ELECTRONICS INC., Seoul (KR)

(72) Inventors: Jaehoon CHUNG, Seoul (KR); Sangmi NOH, Seoul (KR); Sunam KIM, Seoul (KR); Dangoh KIM, Seoul (KR); Seungwon KEUM, Seoul (KR); Juyong LEE, Seoul (KR); Dongho CHO, Seoul (KR)

(73) Assignee: LG ELECTRONICS INC., Seoul (KR)

(21) Appl. No.: 18/681,383

(22) PCT Filed: Sep. 7, 2021
(86) PCT No.: PCT/KR2021/012149

§ 371 Date: Feb. 5, 2024

(51) Int. Cl. H04B 7/06; H04B 7/0452

(52) U.S. Cl. CPC H04B 7/0691; H04B 7/0452

(57) ABSTRACT

A method and an apparatus for allocating subarrays on the basis of direction information and/or distance information about a user are provided. A base station divides a plurality of UEs into first group UEs that are closer than a specific distance to the base station and second group UEs that are farther than the specific distance from the base station. The base station determines, on the basis of the number of streams for the first group UEs, the number of subarrays to be allocated to each UE belonging to the first group UEs and determines, on the basis of a propagation loss for the second group UEs, the number of subarrays to be allocated to each UE belonging to the second group UEs. The base station allows communication by allocating subarrays to each UE on the basis of the determined numbers of subarrays.

### CROSS-REFERENCE TO RELATED APPLICATION(S)

This application is the National Stage filing under 35 U.S.C. 371 of International Application No. PCT/KR2021/012149, filed on Sep. 7, 2021, the contents of which is hereby incorporated by reference herein in its entirety.

### TECHNICAL FIELD

The present disclosure relates to a method and apparatus for allocation subarrays based on user direction and/or distance information.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

With the commercialization of NR, which corresponds to fifth generation (5G) mobile communications technology, research is beginning on sixth generation (6G) mobile communications technology. It is expected that 6G mobile communication technology will utilize frequency bands above 100 GHz. This is expected to increase the number of utilized frequencies by more than 10 times compared to 5G, and further increase the possibility of utilizing spatial resources. These frequency bands above 100 GHz may be referred to as sub-terahertz (sub-THz).

Multiple-Input Multiple-Output (MIMO) is a smart antenna technology for increasing the capacity of wireless communications. MIMO uses multiple antennas in base stations and terminals to increase capacity in proportion to the number of antennas used. In MIMO, the sum rate of data transmissions of all users may vary depending on how resources are allocated to each user.

### SUMMARY

The present disclosure provides a subarray resource allocation method and system using the method that can maximize the sum rate of data transmissions of all users by considering the distance and/or direction of the users, the number of streams according to the base station antenna apertures per each user, and/or beam gains.

In an aspect, a method performed by a base station in a wireless communication system is provided. The method comprises, dividing a plurality of UEs into a first group UEs that are closer than a certain distance to the base station and a second group UEs that are further than a certain distance to the base station, determining a number of subarrays to be allocated to each UE belonging to the first group UEs based on a number of streams for the first group UEs, determining a number of subarrays to be allocated to each UE belonging to the second group UEs based on a propagation loss for the second group UEs, and allocating a subarray to each UE based on the determined number of subarrays and communicating with each UE.

In another aspect, a method performed by a system including a base station and User Equipment (UE) is provided. The method comprises, dividing, by the base station, a plurality of UEs into a first group UEs that are closer than a certain distance to the base station and a second group UEs that are further than a certain distance to the base station based on an initial access signal transmitted by the plurality of UEs, determining, by the base station, a number of subarrays to be allocated to each UE belonging to the first group UEs based on a number of streams for the first group UEs, determining, by the base station, a number of subarrays to be allocated to each UE belonging to the second group UEs based on a propagation loss for the second group UEs, transmitting, by the base station, a training signal to each UE by allocating a subarray based on the determined number of subarrays, calculating, by the plurality of UEs, a magnitude of a received signal for each stream based on the training signal transmitted from the base station, transmitting, by the plurality of UEs, a feedback signal comprising a Modulation and Coding Scheme (MCS) level to the base station, and determining, by the base station, an MCS level for each stream of each UE.

In another aspect, an apparatus for implementing the above method is provided.

The present disclosure can have various advantageous effects.

For example, in the terahertz band or sub-terahertz band, a subarray can be allocated to each user by considering the characteristics of the near and/or far users.

For example, the overall communication capacity of users served by a single base station can be increased.

For example, the same area can be served by fewer base stations, thereby reducing base station installation costs.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of a wireless device to which implementations of the present disclosure are applied.

FIG. 4 shows an example of UE to which implementations of the present disclosure are applied.

FIG. 5 shows an example of a MU-MIMO system to which implementations of the present disclosure are applied.

FIG. 6 shows an example of an array of subarray structure to which implementations of the present disclosure are applied.

FIG. 7 shows an example of Planar Wavefront Model (PWM) to which implementations of the present disclosure are applied.

FIG. 8 shows an example of Spherical Wavefront Model (SWM) to which implementations of the present disclosure are applied.

FIG. 9 shows a simulation of multiplexing gain according to distance in SWM to which implementations of the present disclosure are applied.

FIG. 10 shows a simulation of channel capacity according aperture of the antenna array when the spacing between the antenna arrays is constant in SWM, to which implementations of the present disclosure are applied.

FIG. 11 shows a simulation of channel capacity according aperture of the antenna array when the number of antennas is constant in SWM, to which implementations of the present disclosure are applied.

FIG. 12 shows an example of an aperture of an antenna array subject to which implementations of the present disclosure are applied.

FIGS. 13 and 14 shows an example of an aperture of a base station antenna that is allocated per user to which implementations of the present disclosure are applied.

FIG. 15 shows an example of beamforming after multi-user subarray allocation to which implementations of the present disclosure are applied.

FIG. 16 show an example of a method performed by a base station to which implementations of the present disclosure are applied.

FIG. 17 show an example of a method performed by a UE to which implementations of the present disclosure are applied.

FIG. 18 shows an example of a method for allocating a subarray to which implementations of the present disclosure are applied.

FIG. 19 shows an example of Dₖ, the distance from the base station to each UE k, to which implementations of the present disclosure are applied.

FIG. 20 shows an example of directional information (θ_{m,k}, φ_{m,k}) from each subarray to each UE to which implementations of the present disclosure are applied.

FIG. 21 shows an example of a distance d_{l,m} between each subarray to which implementations of the present disclosure are applied.

FIG. 22 shows an example of a method performed by a system including a base station and a UE to which implementations of the present disclosure are applied.

FIG. 23 shows an example of a method for determining the number of subarrays to be allocated to each UE to which implementations of the present disclosure are applied.

FIGS. 24 and 25 show an example of a method for allocating a subarray to each UE subject to which implementations of the present disclosure are applied.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

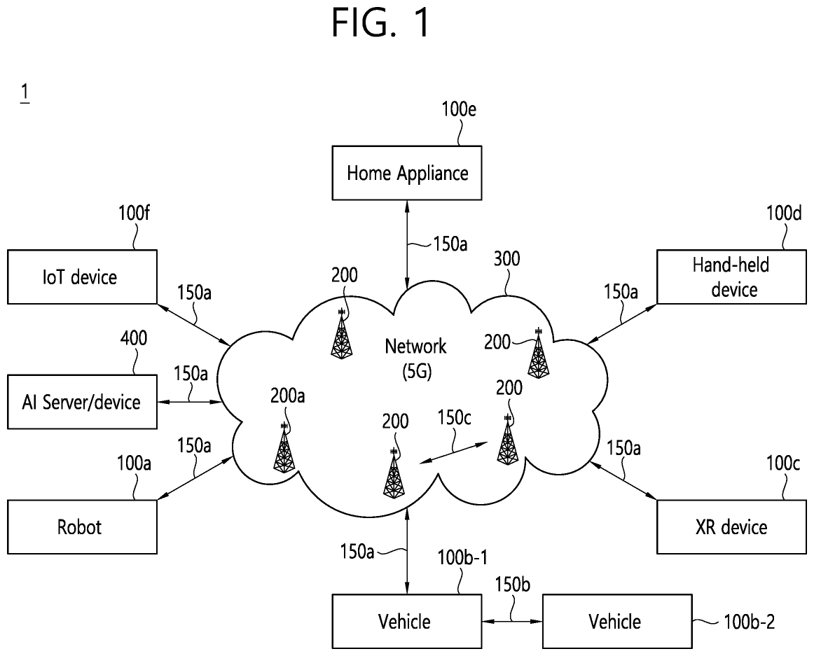

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a Closed-Circuit TV (CCTV), a recorder, or a black box.

The FinTech device may be, for example, a device capable of providing a financial service such as mobile payment. For example, the FinTech device may include a payment device or a Point of Sales (PoS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through Computer Graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 KHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency | Corresponding frequency | Subcarrier |
|---|---|---|
| Range designation | range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | Subcarrier |
|---|---|---|
| designation | range | Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

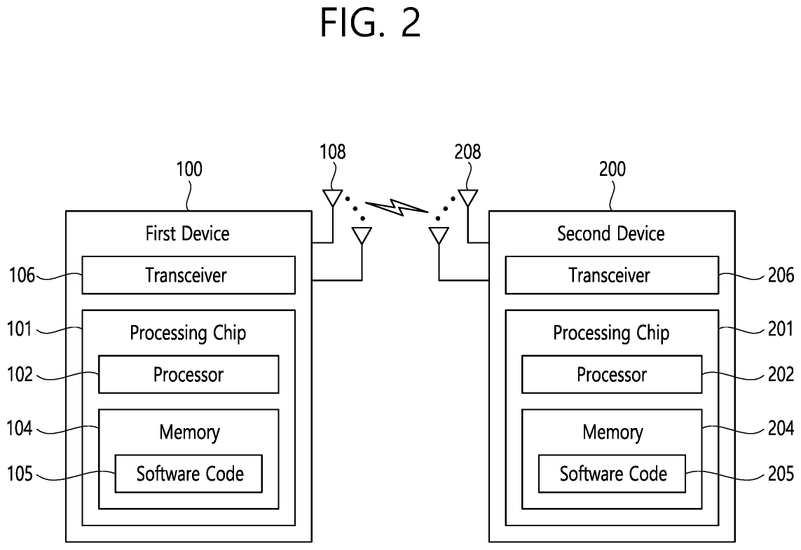

FIG. 2 shows an example of wireless devices to which implementations of the present disclosure are applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs) and/or one or more Service Data Units (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable ROMs (EEPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a Node B (NB), an eNode B (eNB), or a gNB.

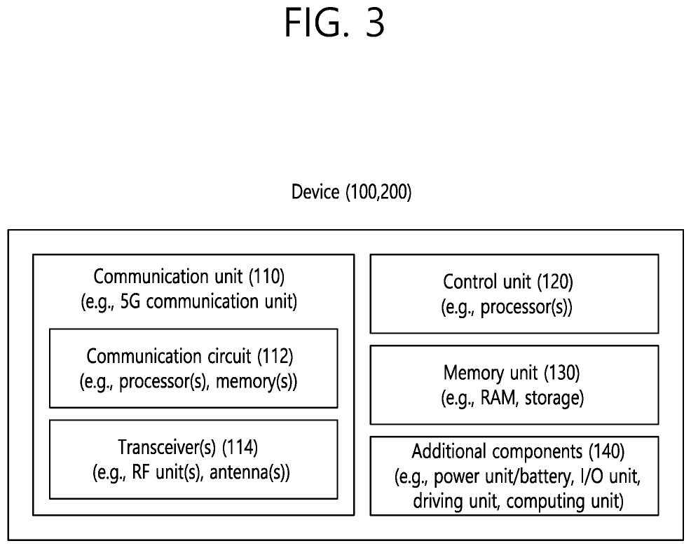

FIG. 3 shows an example of a wireless device to which implementations of the present disclosure are applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, Input/Output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an Application Processor (AP), an Electronic Control Unit (ECU), a Central Processing Unit (CPU), a Graphical Processing Unit (GPU), and a memory control processor. As another example, the memory unit 130 may be configured by a RAM, a Dynamic RAM (DRAM), a ROM, a flash memory, a volatile memory, a non-volatile memory, and/or a combination thereof.

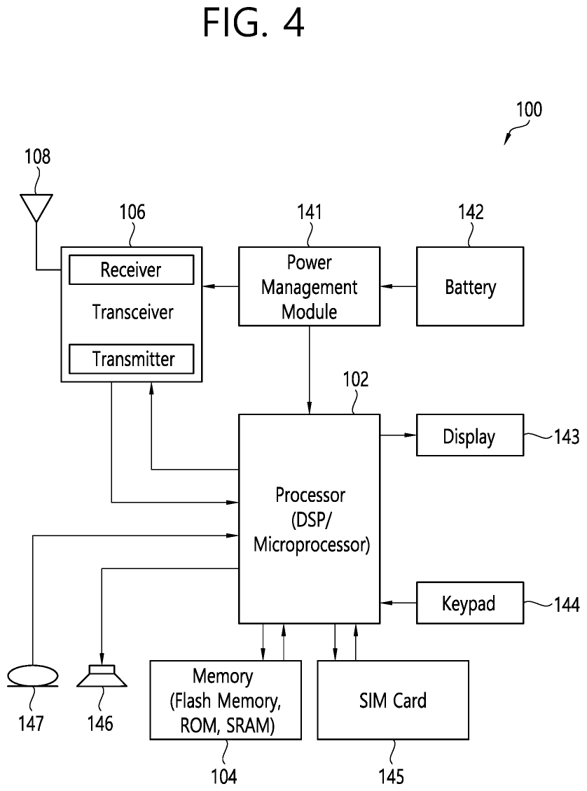

FIG. 4 shows an example of UE to which implementations of the present disclosure are applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

A Multi-User Multiple-Input Multiple-Output (MU-MIMO) system and an Array of Sub-Arrays (AoSA) structure are described below.

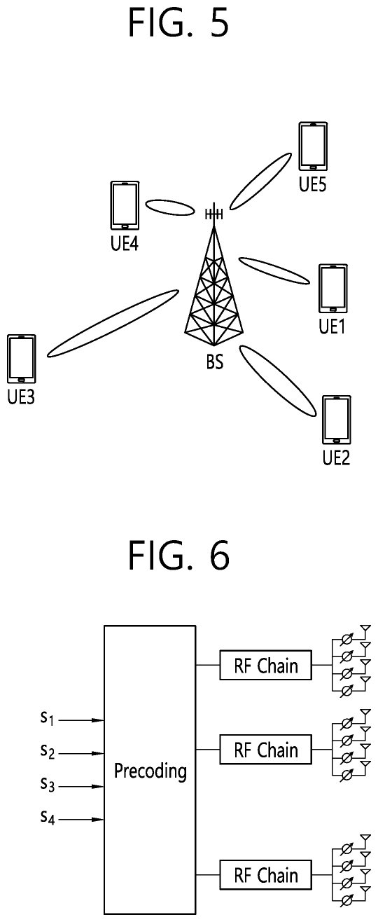

FIG. 5 shows an example of a MU-MIMO system to which implementations of the present disclosure are applied.

As the frequencies used in wireless communications increase, the size of the antennas becomes smaller and the reach of the signal becomes shorter. To compensate for this, MIMO systems that use multiple antennas simultaneously were devised. MIMO systems utilize data precoding in the baseband at the transmitter (e.g., base station) to improve signal reception at the receiver (e.g., UE). In addition, since a single base station supports multiple users in wireless communications, there is active research on MU-MIMO systems, which is MIMO for multiple users.

FIG. 6 shows an example of an array of subarray structure to which implementations of the present disclosure are applied.

For the implementation of a MIMO system, an array antenna may be configured by connecting multiple antennas to a single transmitter or receiver. Meanwhile, the signal to be transmitted is delivered to the antenna by increasing the frequency of the signal from the baseband of the transmitter to the Radio Frequency (RF) band, which requires passing through elements such as a Digital-to-Analog Converter (DAC), frequency mixer, Band-Pass Filter (BPF), and/or Power Amplifier (PA). Collectively, these elements used to convert the signal from the baseband to the RF band are referred to as the RF chain.

Meanwhile, 6G systems may use terahertz (THz) bands or sub-terahertz (sub-THz) bands above 100 GHz. In this case, the size of the antennas may be very small, but the size of the elements in the RF chain may not be small enough to be organized in an array, and it may be difficult to connect the RF chain to every antenna. Therefore, for communications in the terahertz band or sub-terahertz band, an array of subarray structure may be suitable, where multiple antennas are grouped into a single subarray to form a single RF chain.

Referring to FIG. 6, a plurality of RF chains is configured at a transmitter, and a plurality of antennas comprising one subarray are connected to each RF chain.

By connecting a plurality of antennas to a single RF chain, a beam may be formed that drives the signal in a specific direction. Because communications in the terahertz or sub-terahertz bands utilize fine beams with very small beamwidths, the beam emitted by a single subarray may not support multiple users. Therefore, each subarray is likely to be used exclusively by a single user. To support multiple users simultaneously in a MU-MIMO system, the base station may need to allocate different subarrays to each user. With respect to subarray allocation, there have been discussions on how to allocate subarrays by considering the direction in which the user is located, how to allocate subarrays based on channel information, etc.

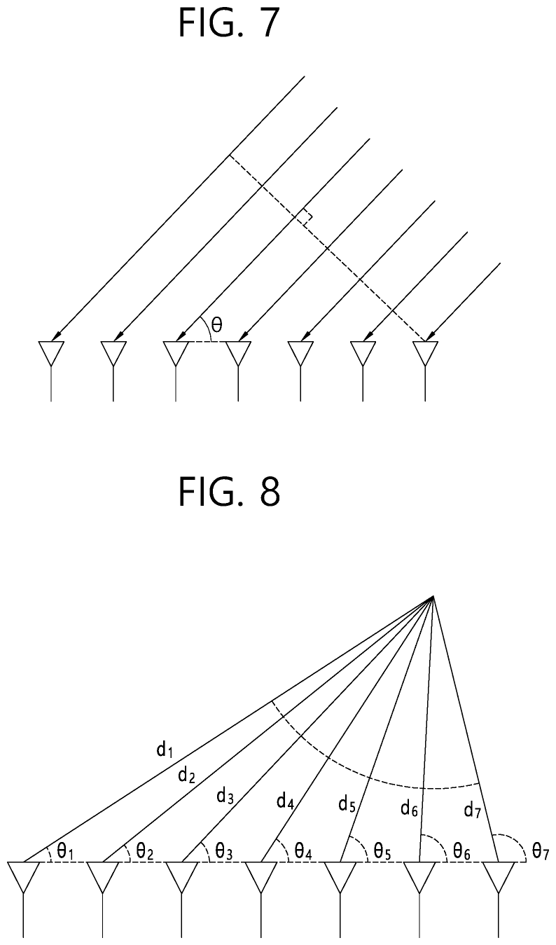

FIG. 7 shows an example of Planar Wavefront Model (PWM) to which implementations of the present disclosure are applied. FIG. 8 shows an example of Spherical Wavefront Model (SWM) to which implementations of the present disclosure are applied.

In conventional beamforming systems, it is assumed that the receiver is in the far-field region relative to the transmitter, so that the wavefronts of electromagnetic waves from the transmitter to the receiver are parallel (i.e., PWM is applied). However, in communication in the terahertz band or sub-terahertz band, the Rayleigh distance separating the far-field region from the Fresnel region is reduced due to the shorter wavelength, and the receiver is more likely to be in the Fresnel region relative to the transmitter due to the shorter travel distance of the signal. Therefore, the assumption that the wavefronts of the electromagnetic waves from the transmitter to the receiver are parallel may no longer be applied, and the assumption that the wavefronts of the electromagnetic waves from the transmitter to the receiver are spherical is required (i.e., SWM is applied).

Referring to FIG. 7, when PWM is applied, the user's direction as observed by all antennas is constant (angle θ) and the distance from each antenna to the user varies at regular intervals. Referring to FIG. 8, when SWM is applied, the direction of the user observed by each antenna varies (angles θ1 to θ7), and the distance from each antenna to the user varies at irregular intervals (distances d1 to d7).

In other words, when SWM is applied instead of PWM to the wavefront of electromagnetic waves from the transmitter to the receiver in communications in the terahertz or sub-terahertz band, the conventional direction-based beamforming method assuming PWM may no longer be applied. Therefore, a beamforming method suitable for SWM is required.

For example, if conventional PWM is applied, multiplexing gain cannot be obtained in a Line-of-Sight (LOS) situation, but if SWM is applied, multiplexing gain can be obtained even in a LoS situation. The closer the distance from the user and the larger the aperture of the transmitting and receiving antennas, the greater the multiplexing gain.

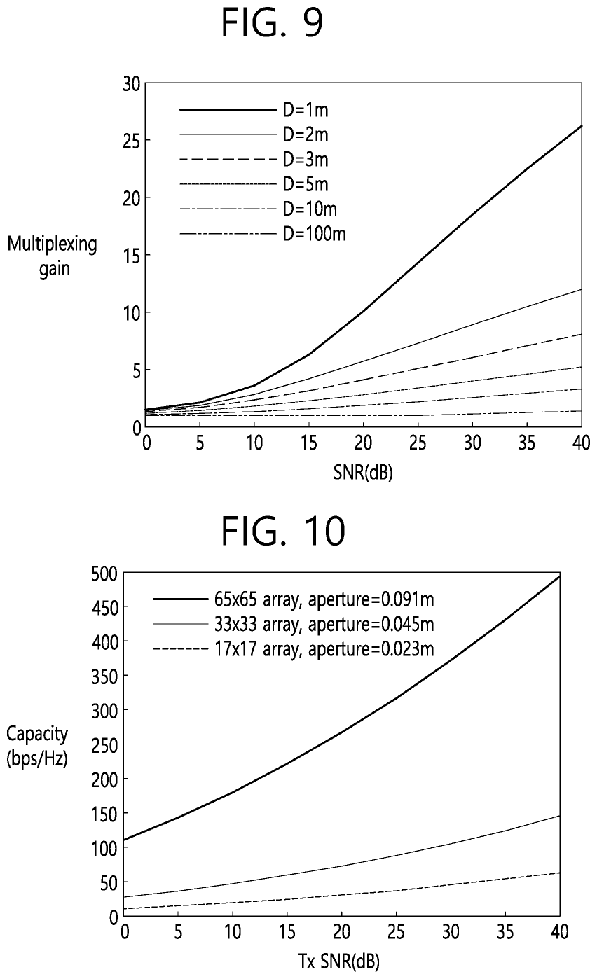

FIG. 9 shows a simulation of multiplexing gain according to distance in SWM to which implementations of the present disclosure are applied.

In the simulation of FIG. 9, the following assumptions are used.
Operating frequency: 150 GHz (λ=2 mm)
MIMO system of 10000×10000
Transmit antenna array: 100×100, 0.5λ spacing, 0.14 m aperture
Receive antenna array: 100×100, 0.5λ spacing, 0.14 m aperture
Raleigh distance: 5 m

Referring to FIG. 9, it can be seen that when SWM is applied, the closer the distance from the user, the greater the multiplexing gain.

FIG. 10 shows a simulation of channel capacity according aperture of the antenna array when the spacing between the antenna arrays is constant in SWM, to which implementations of the present disclosure are applied.

In the simulation of FIG. 10, the following assumptions are used.
Operating frequency: 150 GHz (λ=2 mm)
Transmit antenna array: 0.5λ spacing
Receive antenna array: 0.5λ spacing
Target distance: 1 m

Referring to FIG. 10, it can be seen that when the spacing between the antenna arrays is constant, the higher the number of element antennas included in each antenna array, the higher the aperture of the entire antenna array, which can provide a higher channel capacity.

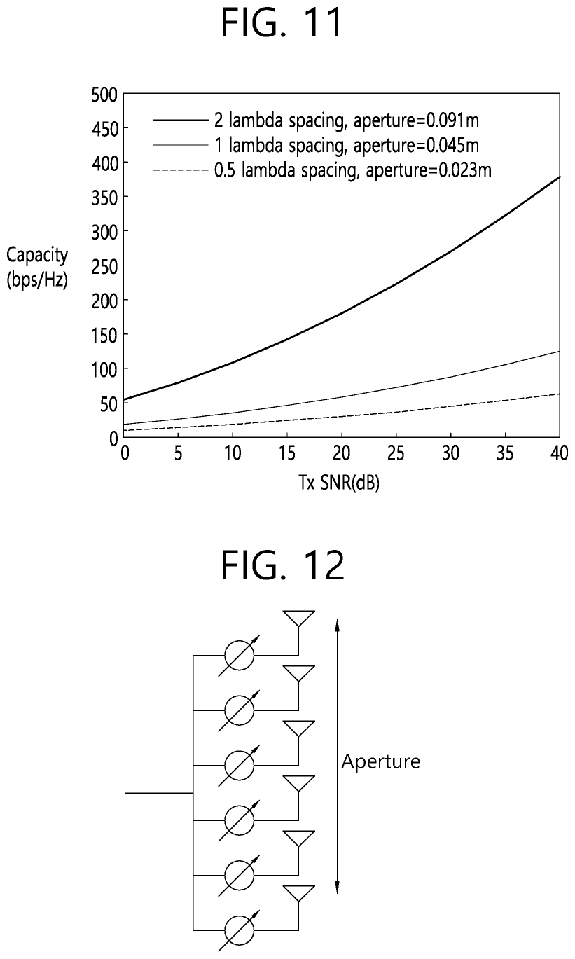

FIG. 11 shows a simulation of channel capacity according aperture of the antenna array when the number of antennas is constant in SWM, to which implementations of the present disclosure are applied.

In the simulation of FIG. 11, the following assumptions are used.
Operating frequency: 150 GHz (λ=2 mm)
Transmit antenna array: 65×65
Receive antenna array: 65×65
Target distance: 1 m

Referring to FIG. 11, it can be seen that when the number of element antennas included in each antenna array is constant, the aperture of the entire antenna array can be increased as the spacing between the element antennas increases, thereby providing a higher channel capacity.

FIG. 12 shows an example of an aperture of an antenna array subject to which implementations of the present disclosure are applied.

Typically, the aperture of an element antenna is defined as the area over which the element antenna can receive electromagnetic waves. Meanwhile, in a system using an antenna array, the same signal is transmitted through an antenna array consisting of multiple element antennas. In the following description, unless otherwise noted, an aperture refers to an aperture of an array of antennas rather than an aperture of an element antenna, and an aperture of an array of antennas is defined as the distance between the two farthest element antennas among multiple antennas transmitting the same signal.

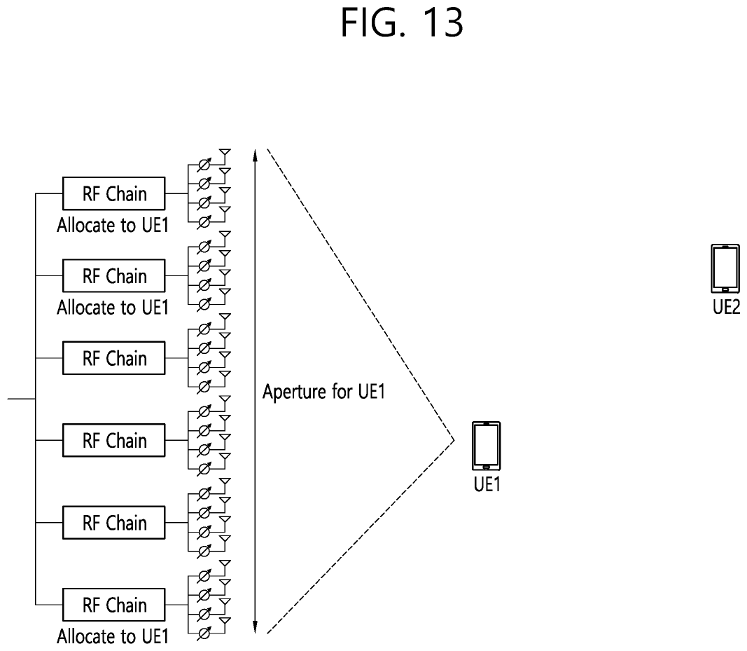

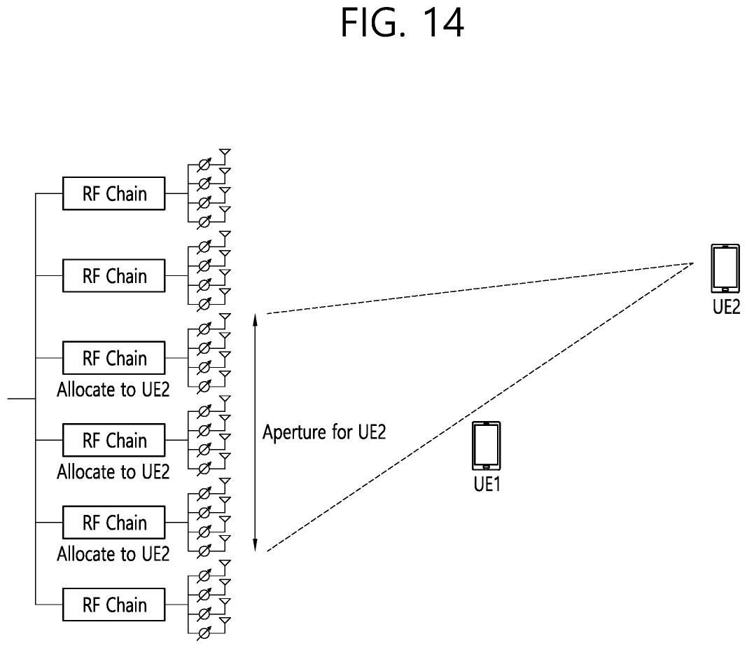

FIGS. 13 and 14 shows an example of an aperture of a base station antenna that is allocated per user to which implementations of the present disclosure are applied.

In a MU-MIMO system using an AoSA structure, the distance between the two farthest element antennas from among a plurality of element antennas belonging to a plurality of subarrays allocated to a single user may be defined as the aperture of the array antennas.

Referring to FIG. 13, the RF chains allocated to UE1 are the first, second, and sixth RF chains. Therefore, the aperture of the array antennas for UE1 is the distance between the two farthest element antennas, from among element antennas connected to the first RF chain and element antennas connected to the sixth RF chain.

Referring to FIG. 14, the RF chains allocated to UE2 are the third, fourth, and fifth RF chains. Therefore, the aperture of the array antennas for UE2 is the distance between the two farthest element antennas, from among element antennas connected to the third RF chain and element antennas connected to the fifth RF chain.

Hereinafter, a SWM-based multi-user subarray allocation method suitable for communication in the terahertz band or sub-terahertz band is proposed, according to implementations of the present disclosure.

According to implementations of the present disclosure, a subarray may be allocated to each user in consideration of the different characteristics of users located in the Fresnel region and users located in the far-field region in the terahertz band or sub-terahertz band. That is, a subarray may be allocated to each user in order to maximize the multiplexing gain for users located in the Fresnel region and to maximize the beam gain for users located in the far-field region. Accordingly, the sum rate of data transmissions of all users can be maximized.

According to implementations of the present disclosure, a subarray may be allocated to each user by considering not only the user's direction information, but also the user's distance information and/or the aperture of the entire antenna array allocated to each user. More specifically, the base station may determine the number of subarrays to be allocated to each user by considering the optimal number of streams and the required beam gain per stream based on the user's distance, and may allocate a subarray ID to satisfy an aperture size to support the number of streams allocated per user.

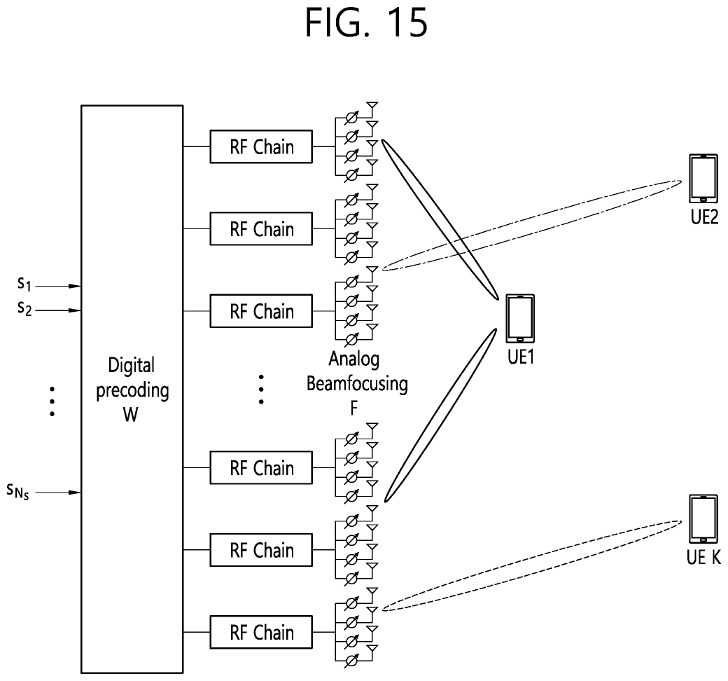

FIG. 15 shows an example of beamforming after multi-user subarray allocation to which implementations of the present disclosure are applied.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

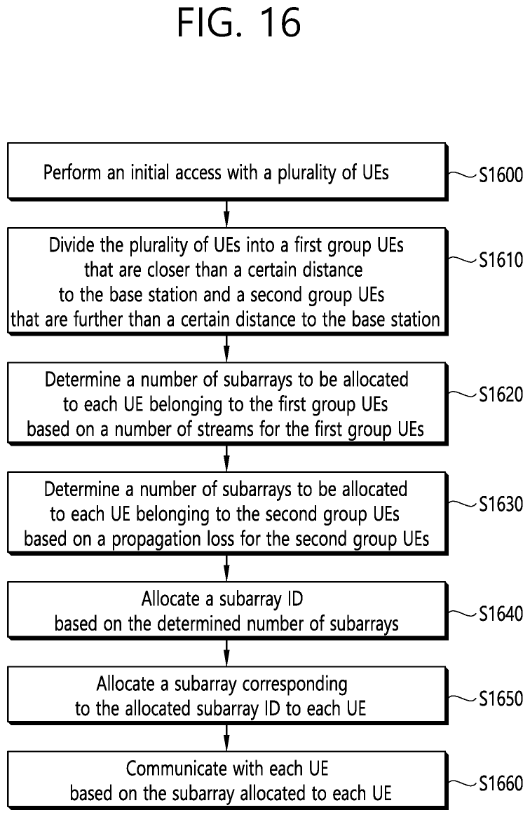

FIG. 16 show an example of a method performed by a base station to which implementations of the present disclosure are applied.

In step S1600, the method comprises performing an initial access with a plurality of UEs.

In step S1610, the method comprises dividing the plurality of UEs into a first group UEs that are closer than a certain distance to the base station and a second group UEs that are further than a certain distance to the base station.

In some implementations, a distance between the base station and the plurality of UEs may be determined based on an uplink access signal received from the plurality of UEs and/or a downlink training signal transmitted by the base station.

In step S1620, the method comprises, for the first group UEs, determining a number of subarrays to be allocated to each UE belonging to the first group UEs based on a number of streams.

In step S1630, the method comprises, for the second group UEs, determining a number of subarrays to be allocated to each UE belonging to the second group UEs based on a propagation loss.

In step S1640, the method comprises allocating a subarray ID based on the determined number of subarrays.

In step S1650, the method comprises allocating a subarray corresponding to the allocated subarray ID to each UE.

In step S1660, the method comprises communicating with each UE based on the subarray allocated to each UE.

In some implementations, determining the number of subarrays to be allocated to each UE belonging to the first group UEs and/or the number of subarrays to be allocated to each UE belonging to the second group UEs may further comprise, updating the number of subarrays to be allocated to each UE belonging to the first group UEs and/or the number of subarrays to be allocated to each UE belonging to the second group UEs. In this case, the updating may comprise, based on a sum of the number of subarrays to be allocated to each UE belonging to the first group UEs and the number of subarrays to be allocated to each UE belonging to the second group UEs being greater than a total number of subarrays of the base station, reducing the number of subarrays to be allocated to UEs belonging to the first group UEs in priority to the number of subarrays to be allocated to UEs belonging to the second group UEs. Or, the updating may comprise, based on a sum of the number of subarrays to be allocated to each UE belonging to the first group UEs and the number of subarrays to be allocated to each UE belonging to the second group UEs being less than a total number of subarrays of the base station, increasing the number of subarrays to be allocated to UEs belonging to the first group UEs in priority to the number of subarrays to be allocated to UEs belonging to the second group UEs.

In some implementations, the method may further comprise calculating a required aperture, for each UE belonging to the first group UEs and for each UE belonging to the second group UEs.

In some implementations, allocating the subarray ID based on the determined number of subarrays further may comprise, allocating a reference subarray ID for each UE belonging to the first group UEs and for each UE belonging to the second group UEs. For the first group UEs, the reference subarray ID may be a subarray ID at an edge based on a direction of each UE belonging to the first group UEs, and a subarray corresponding to the reference subarray ID may be a subarray having a largest angle between each UE belonging to the first group UEs. In addition, for the second group UEs, the reference subarray ID may be a subarray ID closest to a direction of each UE based on the direction of each UE belonging to the second group UEs, and a subarray corresponding to the reference subarray ID may be a subarray having a smallest angle between each UE belonging to the second group UEs.

In some implementations, allocating the subarray ID based on the determined number of subarrays may further comprise, for the first group UEs, allocating a first additional subarray ID distant from the reference subarray ID for the first group UEs by the required aperture for each UE, and for the second group UEs, allocating a second additional subarray ID that is less distant from the reference subarray ID for the second group UEs.

In some implementations, allocating the subarray ID based on the determined number of subarrays may further comprise, allocating a third additional subarray ID for the first group UEs and a fourth additional subarray ID for the second group UEs, based on the required aperture for each UE being greater than an aperture for each UE. The third additional subarray ID may be allocated in priority to the fourth additional subarray ID. The third additional subarray ID may be allocated such that a minimum value of a distance from the first additional subarray ID is greatest, and the fourth additional subarray ID may be allocated such that a minimum value of a distance from the second additional subarray ID is smallest.

Furthermore, the method in perspective of the base station described above in FIG. 16 may be performed by the second wireless device 200 shown in FIG. 2, and/or the wireless device 100 shown in FIG. 3.

More specifically, the base station comprises at least one transceiver, at least one processor, and at least one memory operably connectable to the at least one processor and storing instructions that, based on being executed by the at least one processor, perform operations below.

The base station performs, via the at least one transceiver, an initial access with a plurality of UEs.

The base station divides the plurality of UEs into a first group UEs that are closer than a certain distance to the base station and a second group UEs that are further than a certain distance to the base station.

In some implementations, a distance between the base station and the plurality of UEs may be determined based on an uplink access signal received from the plurality of UEs and/or a downlink training signal transmitted by the base station.

The base station, for the first group UEs, determines a number of subarrays to be allocated to each UE belonging to the first group UEs based on a number of streams.

The base station, for the second group UEs, determines a number of subarrays to be allocated to each UE belonging to the second group UEs based on a propagation loss.

The base station allocates a subarray ID based on the determined number of subarray's.

The base station allocates a subarray corresponding to the allocated subarray ID to each UE.

The base station communicates, via the at least one transceiver, with each UE based on the subarray allocated to each UE.

In some implementations, determining the number of subarrays to be allocated to each UE belonging to the first group UEs and/or the number of subarrays to be allocated to each UE belonging to the second group UEs may further comprise, updating the number of subarrays to be allocated to each UE belonging to the first group UEs and/or the number of subarrays to be allocated to each UE belonging to the second group UEs. In this case, the updating may comprise, based on a sum of the number of subarrays to be allocated to each UE belonging to the first group UEs and the number of subarrays to be allocated to each UE belonging to the second group UEs being greater than a total number of subarrays of the base station, reducing the number of subarrays to be allocated to UEs belonging to the first group UEs in priority to the number of subarrays to be allocated to UEs belonging to the second group UEs. Or, the updating may comprise, based on a sum of the number of subarrays to be allocated to each UE belonging to the first group UEs and the number of subarrays to be allocated to each UE belonging to the second group UEs being less than a total number of subarrays of the base station, increasing the number of subarrays to be allocated to UEs belonging to the first group UEs in priority to the number of subarrays to be allocated to UEs belonging to the second group UEs.

In some implementations, the base station may further calculate a required aperture, for each UE belonging to the first group UEs and for each UE belonging to the second group UEs.

In some implementations, allocating the subarray ID based on the determined number of subarrays further may comprise, allocating a reference subarray ID for each UE belonging to the first group UEs and for each UE belonging to the second group UEs. For the first group UEs, the reference subarray ID may be a subarray ID at an edge based on a direction of each UE belonging to the first group UEs, and a subarray corresponding to the reference subarray ID may be a subarray having a largest angle between each UE belonging to the first group UEs. In addition, for the second group UEs, the reference subarray ID may be a subarray ID closest to a direction of each UE based on the direction of each UE belonging to the second group UEs, and a subarray corresponding to the reference subarray ID may be a subarray having a smallest angle between each UE belonging to the second group UEs.

In some implementations, allocating the subarray ID based on the determined number of subarrays may further comprise, for the first group UEs, allocating a first additional subarray ID distant from the reference subarray ID for the first group UEs by the required aperture for each UE, and for the second group UEs, allocating a second additional subarray ID that is less distant from the reference subarray ID for the second group UEs.

In some implementations, allocating the subarray ID based on the determined number of subarrays may further comprise, allocating a third additional subarray ID for the first group UEs and a fourth additional subarray ID for the second group UEs, based on the required aperture for each UE being greater than an aperture for each UE. The third additional subarray ID may be allocated in priority to the fourth additional subarray ID. The third additional subarray ID may be allocated such that a minimum value of a distance from the first additional subarray ID is greatest, and the fourth additional subarray ID may be allocated such that a minimum value of a distance from the second additional subarray ID is smallest.

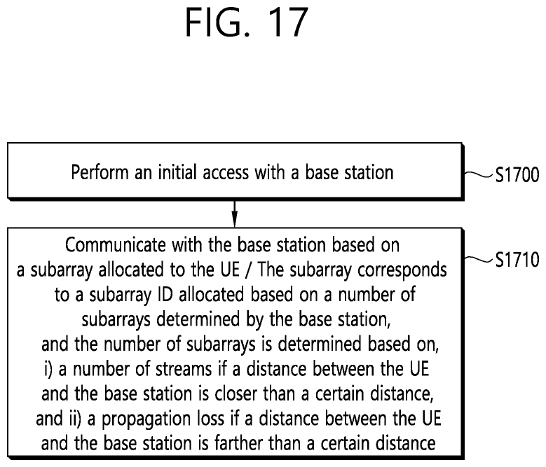

FIG. 17 show an example of a method performed by a UE to which implementations of the present disclosure are applied.

In step S1700, the method comprises performing an initial access with a base station.

In step S1700, the method comprises communicating with the base station based on a subarray allocated to the UE.

The subarray corresponds to a subarray ID allocated based on a number of subarrays determined by the base station, and the number of subarrays is determined based on, i) a number of streams if a distance between the UE and the base station is closer than a certain distance, and ii) a propagation loss if a distance between the UE and the base station is farther than a certain distance.

Furthermore, the method in perspective of the UE described above in FIG. 17 may be performed by the first wireless device 100 shown in FIG. 2, the wireless device 100 shown in FIG. 3, and/or the UE 100 shown in FIG. 4.

More specifically, the UE comprises at least one transceiver, at least one processor, and at least one memory operably connectable to the at least one processor and storing instructions that, based on being executed by the at least one processor, perform operations below:

The UE performs, via the at least one transceiver, an initial access with a base station.

The UE communicates, via the at least one transceiver, with the base station based on a subarray allocated to the UE,

The subarray corresponds to a subarray ID allocated based on a number of subarrays determined by the base station, and the number of subarrays is determined based on, i) a number of streams if a distance between the UE and the base station is closer than a certain distance, and ii) a propagation loss if a distance between the UE and the base station is farther than a certain distance.

Furthermore, the method in perspective of the UE described above in FIG. 17 may be performed by control of the processor 102 included in the first wireless device 100 shown in FIG. 2, by control of the communication unit 110 and/or the control unit 120 included in the wireless device 100 shown in FIG. 3, and/or by control of the processor 102 included in the UE 100 shown in FIG. 4.

More specifically, a processing apparatus operating in a wireless communication system comprises at least one processor, and at least one memory operably connectable to the at least one processor. The at least one processor is configured to perform operations comprising communicating with a base station based on a subarray: The subarray corresponds to a subarray ID allocated based on a number of subarrays determined by the base station, and the number of subarrays is determined based on, i) a number of streams if a distance to the base station is closer than a certain distance, and ii) a propagation loss if a distance to the base station is farther than a certain distance.

Furthermore, the method in perspective of the UE described above in FIG. 17 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as synchronous dynamic random access memory (SDRAM), ROM, non-volatile random access memory (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory computer-readable medium (CRM) has stored thereon a plurality of instructions.

More specifically, at least one CRM stores instructions that, based on being executed by at least one processor, perform operations comprising communicating with a base station based on a subarray. The subarray corresponds to a subarray ID allocated based on a number of subarrays determined by the base station, and the number of subarrays is determined based on, i) a number of streams if a distance to the base station is closer than a certain distance, and ii) a propagation loss if a distance to the base station is farther than a certain distance.

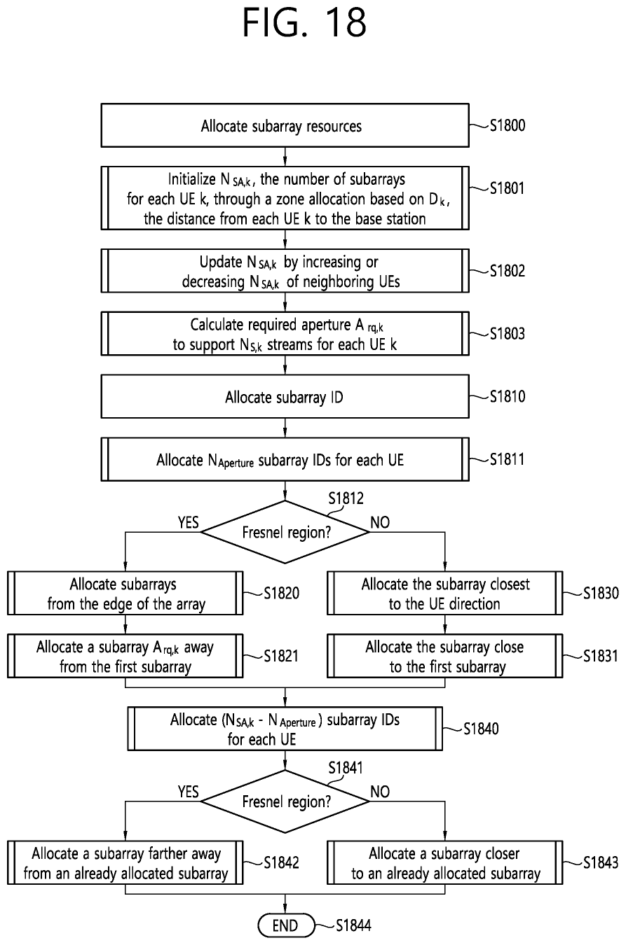

Hereinafter, a method for allocating a number of subarrays and a method for allocating a subarray ID for each UE will be described in more detail with reference to FIG. 18.

FIG. 18 shows an example of a method for allocating a subarray to which implementations of the present disclosure are applied.

1. Step S1800: The base station allocates subarray resources. That is, the base station allocates the number of subarrays to be allocated to each UE.

(1) Step S1801: The base station initializes (i.e., sets initial values for) N_{SA,k}, the number of streams for each UE k and the number of subarrays to be allocated to each UE k, through a zone allocation based on Dₖ, the distance from each UE k to the base station.

a) The base station determines the zone to which each UE k belongs based on Dₖ, the distance to each UE k from the base station. The base station may know Dₖ, the distance to each UE k, in various ways, including the following ways.
Using uplink access signals from UEs: Each UE k transmits an uplink access signal to the base station, and the base station may use the received uplink access signal to determine the distance to each UE k, Dₖ.
Using a downlink training signal from the base station: The base station broadcasts a downlink training signal to each UE k, and each UE k may feedback Dₖ, the distance to the base station based on the received signal magnitude.

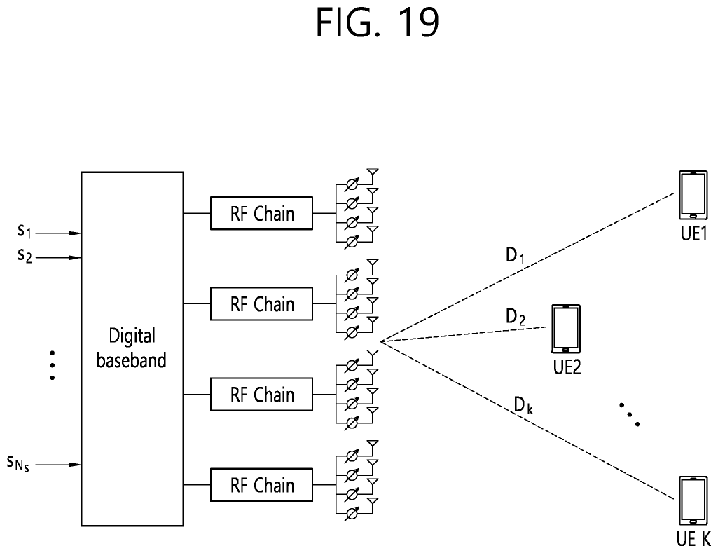

FIG. 19 shows an example of Dₖ, the distance from the base station to each UE k, to which implementations of the present disclosure are applied.

Return to FIG. 18 again.

b) The base station derives N_{Gain,k}, the minimum number of subarrays per stream to overcome propagation losses due to distance in each zone.

c) The base station sets K, the number of UEs that can be supported to receive at least one stream per UE, and distant UEs exceeding it (k>K) are classified as being in the out-of-coverage zone. In other words, if the UEs are guaranteed to receive at least one stream per UE, the number of subarrays N_{SA} of the base station may satisfy Equation 1 below.

$${N}_{SA} \geq {\sum }_{k = 1}^{K} {N}_{Gain , k} \qquad [ Equation 1 ]$$

d) The base station derives N_{S,k}, the optimal number of streams according to the distance Dₖ of each UE k (k=1, 2, . . . , K).

e) The base station sets the initial value of N_{SA,k}, the number of subarrays to be allocated for each UE k. N_{SA,k} may be set by Equation 2 below.

$${N}_{SA , k} = {N}_{S , k} \times {N}_{Gain , k} \qquad [ Equation 2 ]$$

Table 3 shows, when the number of zones is four, N_{S,k}, the optimal number of streams in each zone, N_{Gain,k}, the minimum number of subarrays per stream to overcome propagation losses in each zone, and the zone types based on them.

TABLE 3

| | N_{S,k} | N_{Gain,k} | Zone Type |
|---|---|---|---|
| Zone 1 | 8 | 1 | First group |
| Zone 2 | 4 | 2 | N_{S,k} > 1 |
| Zone 3 | 2 | 4 | Second group |
| Zone 4 | 1 | 8 | N_{S,k} = 1 |

| | |
|---|---|
| Out of coverage | Do not service |

Referring to Table 3, zones 1 and 2 may be classified as first group zone, and zones 3 and 4 may be classified as second group zone. The first group zone may correspond to the Fresnel zone, and the second group zone may correspond to the far-field region. For UEs in the first group zone, N_{S,k}>1 may be assumed since the number of optimal streams is important. For UEs in the second group zone, N_{S,k}=1 may be assumed since it is important to overcome propagation losses.

(2) Step S1802: The base station updates N_{SA,k}, the number of subarrays per UE k to which the initial value is set. The base station updates N_{SA,k} by increasing or decreasing N_{SA,k} of neighboring UEs.

a) If the total sum of N_{SA,k} determined in (1) above is more than the number of subarrays the base station has (i.e., subarray resources are insufficient), the base station may reduce the number of optimal streams N_{S,k} starting from the UEs in the near-field zone. For UEs in the same zone, the base station may reduce the number of optimal streams N_{S,k} starting from the UE with the lower priority. The method for determining the priority may include the following examples.
Reduce the number of optimal streams from UEs with farther distances Dₖ between the base station and each UE
Reduce the number of optimal streams from UEs that contribute less to the sum rate of the total data transmissions
Reduce the number of optimal streams from UEs that pay less (i.e., lower Cass rank)
Reduce the number of optimal streams from UEs with lower required Quality of Service (Qos)

The pseudocode in Equation 3 below is an example of a mathematical representation of the method in (2)a) above.

[Equation 3].

```
If Σₖ N_{SA,k} > N_{SA}
For n = 1:N_{zone}
  N_{S,k} = N_{S,k}−1 and N_{SA,k} = N_{SA,k}−1 ∀ k ∈ Kₙ,
where Kₙ is the set of UEs in zone n.
  If Σₖ N_{SA,k} < N_{SA}
N_{S,k} = N_{S,k} +1 and N_{SA,k} = N_{SA,k}+1
for (N_{SA} − Σₖ N_{SA,k}) UEs k ∈ Mₙ, with bigger Dₖ,
  If Σₖ N_{SA,k} = N_{SA}, break
```

b) If the total sum of N_{SA,k} determined in (1) above is less than the number of subarrays that the base station has (i.e., subarray resources remain), the base station may increase the number of subarrays N_{SA,k} to be allocated, starting with UEs in the near-field zone. Increasing the number of subarrays to be allocated to UEs in the near-field zone increases the beam gain, which can increase the received Signal-to-Noise Ratio (SNR) of UEs in the near-field zone and thus increase the sum rate of the total data transmissions. For UEs in the same zone, the base station may increase the number of subarrays N_{SA,k} to be allocated, starting from UE with the higher priority. The method for determining the priority may include the following examples.
Increase the number of subarrays to be allocated from UEs that are closer in distance Dₖ to the base station
Increase the number of subarrays to be allocated from UEs that contribute more to the sum rate of the total data transmissions
Increase the number of subarrays to be allocated from UEs that pay a lot of fees (i.e., higher Cass rank).
Increase the number of subarrays to be allocated from UEs with higher required QoS.

The pseudocode in Equation 4 below is an example of a mathematical representation of the method in (2)b) above.

[Equation 4]

```
If Σₖ N_{SA,k} < N_{SA}
For n = 1:N_{zone}
N_{S,k} = N_{S,k} + 1 and N_{SA,k} = N_{SA,k} + 1 ∀ k ∈ Mₙ,
where Mₙ is the set of UEs in zone n.
  If Σₖ N_{SA,k} > N_{SA}
    N_{S,k} = N_{S,k} −1 and N_{SA,k} = N_{SA,k}−1
for (Σₖ N_{SA,k} − N_{SA}) UEs k ∈ Mₙ with bigger Dₖ,
  If Σₖ N_{SA,k} = N_{SA}, break
```

c) If the total sum of N_{SA,k} determined in (1) above is equal to the number of subarrays the base station has, the base station performs the operation in (3) below.

(3) Step S1803: For each UE k, the base station calculates the distance Dₖ from the base station and the aperture A_{rq,k} required to support the N_{S,k} streams.

2. Step S1810: The base station allocates subarray IDs.

(1) The base station defines a set of subarray IDs. The entire set of subarray IDs M may be defined by Equation 5.

$$M = \{ {m}_{1} , {m}_{2} , … , {m}_{{N}_{SA}} \} \qquad [ Equation 5 ]$$

The set of subarray IDs Mk to be allocated to UE k may be defined by Equation 6.

$${M}_{k} = \{ \} ∀ k \qquad [ Equation 6 ]$$

(2) Steps S1811, S1812: The base station allocates N_{Aperture} number of subarray IDs for each UE k. The base station may allocate N_{Aperture} number of subarray IDs starting from UEs in the near-field zone (i.e., Fresnel region). N_{Aperture} may refer to the minimum number of antennas required to determine the aperture of the entire antenna.

a-1) Step S1820: The base station allocates a first subarray ID to UEs belonging to the near-field zone. The first subarray ID may be a reference subarray ID. The first subarray ID and/or the reference subarray ID may correspond to a subarray ID at an edge determined using the direction information of the UE belonging to the near-field zone. That is, the subarray ID with the largest angle between the subarray and the UE may be allocated as the first subarray ID and/or the reference subarray ID for the UE belonging to the near-field zone.

a-2) Step S1830: The base station allocates a first subarray ID to UEs belonging to the far-field zone. The first subarray ID may be a reference subarray ID. The first subarray ID and/or the reference subarray ID may correspond to a subarray ID that is closest to the direction of the UE determined using the direction information of the UE belonging to the far-field zone. That is, the subarray ID with the smallest angle between the subarray and the UE may be allocated as the first subarray ID and/or the reference subarray ID for the UE in the far-field zone.

The base station may know the direction information (θ_{m,k}, φ_{m,k}) of each UE per subarray through various methods, including the following examples.
The base station may know the direction information (e.g., Angle of Arrival (AoA)) of each UE per subarray using uplink access signals received from the UE.
The base station may know the direction information (e.g., Angle of Departure (AoD)) of each UE per subarray using downlink training signals transmitted by the base station to the UE.

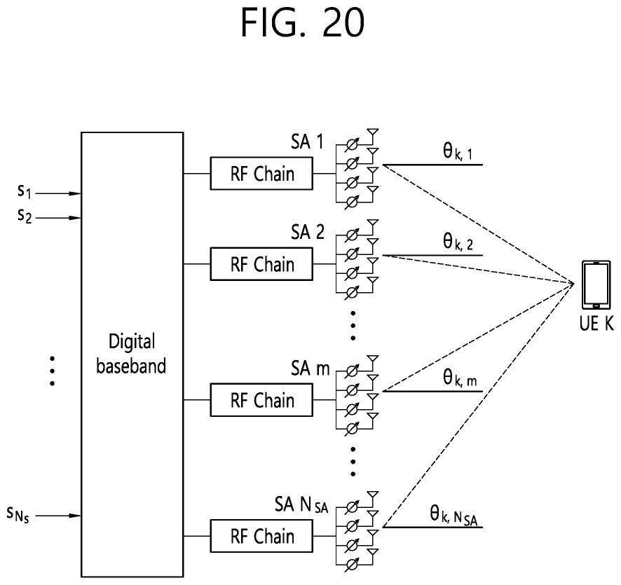

FIG. 20 shows an example of directional information (θ_{m,k}, φ_{m,k}) from each subarray to each UE to which implementations of the present disclosure are applied.

Return to FIG. 18 again.

b-1) Step S1821: The base station allocates the remaining N_{Aperture-1} subarray IDs to the UEs in the near-field zone. The base station allocates a subarray ID that is A_{rq,k} away from the first subarray ID for the UEs in the near-field zone allocated in 2)a-1) above.

b-2) Step S1831: The base station allocates the remaining N_{Aperture-1} subarray IDs to the UEs belonging to the far-field zone. The base station allocates a subarray ID that is closest to the first subarray ID for the UEs in the far-field zone allocated in 2)a-2) above.

The base station may determine the distance d_{l,m} between each subarray through various methods, including the following examples.
The base station may use the base station's self-training signal to determine the distance d_{l,m} between each subarray. More specifically, when a particular subarray transmits a self-training signal, the remaining subarrays except for that subarray receive the self-training signal, and the base station may determine the distance d_{l,m} between each subarray based on the magnitude of the received signal.
The base station may use the array geometry information embedded in the base station installation to determine the distance d_{l,m} between each subarray.

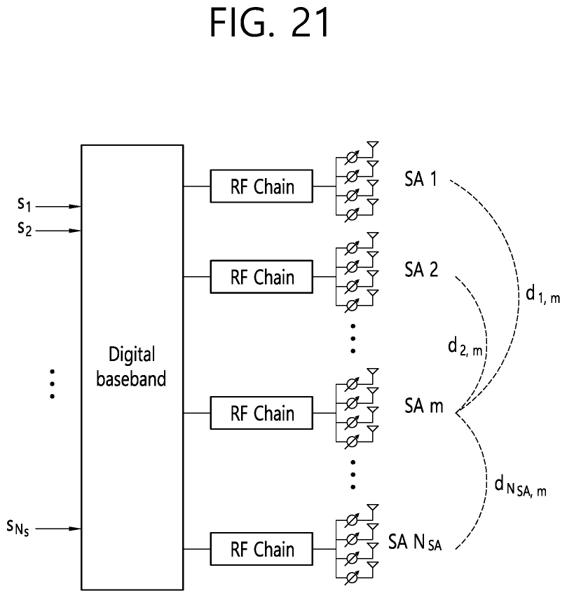

FIG. 21 shows an example of a distance d_{l,m} between each subarray to which implementations of the present disclosure are applied.

Return to FIG. 18 again.

The pseudocode in Equation 7 below is an example of a mathematical representation of the method in (2) above.

```
[Equation 7]
For n = 1:N_{zone}
  If N_{s,k} > 1
    For k = 1:length(Zₙ), where Zₙ is the set of UEs in zone n
    Let m₁ ∉ M and m₁ ∈ Mₖ such that
    ${m}_{1} ∈ \{ {m}_{i} \vert arg {max}_{{m}_{i}} \vert {ϕ}_{{m}_{i} , k} \vert ⋂ arg {max}_{{m}_{i}} \vert {θ}_{{m}_{i} , k} \vert \} .$
    where Mₖ is the set of subarrays allocated to UE k
    For i = 2:N_{Aperture}
      Let mᵢ ∈ M and mᵢ ∈ Mₖ for i such that
      ${A}_{rq , k} \leq {d}_{i , 1} < {A}_{rq , k} + {d}_{min} , where {d}_{min} = {min}_{i , j} {d}_{i , j}$
  If Nsx = 1
    For k = 1:length(Zₙ), where Zₙ is the set of UEs in zone n
    Let m₁ ∉ M and m₁ ∈ Mₖ such that
    ${m}_{1} ∈ \{ {m}_{i} \vert arg {min}_{{m}_{i}} \vert {ϕ}_{{m}_{i} , k} \vert ⋂ arg {min}_{{m}_{i}} \vert {θ}_{{m}_{i} , k} \vert \}$
    For i = 2:N_{Aperture}
      $Let {m}_{i} ∉ M and {m}_{i} ∈ {M}_{k} such that SA {arg min}_{{m}_{i}} ( {d}_{{m}_{i} , {m}_{1}} )$
```

(3) Steps S1840, S1841: The base station further allocates (N_{SA,k}−N_{Aperture}) subarray IDs for each UE k.

(a) The base station may check whether each UE k satisfies the required aperture A_{rq,k} and determine the priority to allocate additional subarray IDs. That is, the base station may calculate the aperture Aₖ for each UE, check whether A_{rq,k}>Aₖ for each UE, and prioritize the allocation of additional subarray IDs starting from UEs belonging to the near-field zone that lack aperture.

(b) Step S1842: The base station allocates the additional subarray ID to the UEs belonging to the near-field zone such that the minimum value of the distance from the subarray ID already allocated in (1)(2) above is the largest.

(c) Step S1843: The base station allocates the additional subarray ID to the UEs belonging to the far-field zone such that the minimum value of the distance from the subarray ID already allocated in (1)(2) above is the smallest.

The pseudocode in Equation 8 below is an example of a mathematical representation of the method in (3) above.

```
[Equation 8]
  For n = 1:N_{zone}
    If N_{S,k} ≥ N_{Gain,k}
      For k = 1:length(Zₙ), where Zₙ is the set of UEs in zone n
        For i = 1:(N_{SA,k} − N_{Aperture})
          Let   mᵢ ∈ Mₖ   such   that   SA
${arg max}_{{m}_{i}} [ {min}_{{m}_{i}} \{ {d}_{{m}_{i} , {m}_{1}} , ⋯ , {d}_{{m}_{i} , {m}_{{N}_{Aperture}}} \} ]$
          where Mₖ is the set of subarrays allocated to UE k
    If N_{s,k} < N_{Gain,k}
      For k = 1:length(Zₙ), where Zₙ is the set of UEs in zone n
        For i = 1:(N_{SA,k} − N_{Aperture})
          Let   mᵢ ∈ Mₖ   such   that   SA
${arg max}_{{m}_{i}} [ {min}_{{m}_{i}} \{ {d}_{{m}_{i} , {m}_{1}} , ⋯ , {d}_{{m}_{i} , {m}_{{N}_{Aperture}}} \} ]$
          where Mx is the set of subarrays allocated to UE k
```

(4) The base station may update the number of streams according to the required aperture A_{rq,k} for each UE k.

(a) The base station may update the aperture Aₖ for each UE k and check whether A_{rq,k}>Aₖ for each UE.

(b) The base station may update the number of optimal streams N_{S,k} according to the updated Aₖ.

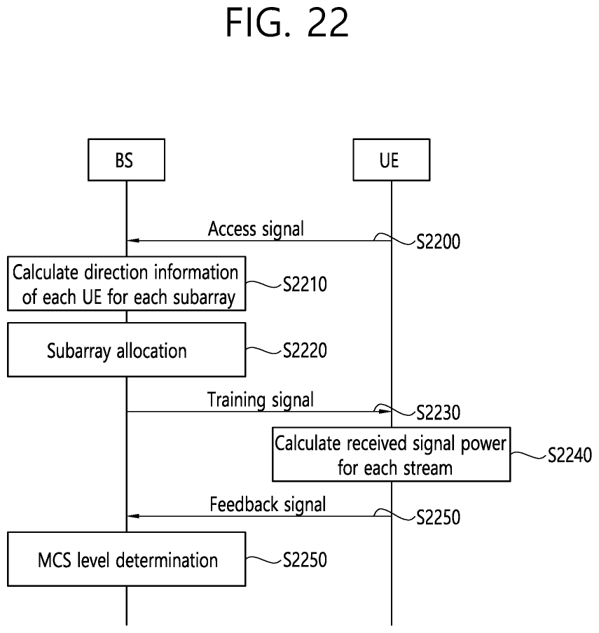

FIG. 22 shows an example of a method performed by a system including a base station and a UE to which implementations of the present disclosure are applied.

The system may be a MU-MIMO system. When applying implementations of the present disclosure to a MU-MIMO system, a particular UE and base station may perform the following operations.

In step S2200, each UE transmits an initial access signal to the base station.

In step S2210, the base station may calculate the angle between each subarray and the particular UE, i.e., the direction information of the particular UE, based on the difference in the phase values of the initial access signals received by each subarray.

In step S2220, the base station allocates a subarray for each UE using the method described above in FIG. 18.

The base station divides the plurality of UEs into a first group UEs that are closer than a certain distance to the base station and a second group UEs that are further than a certain distance to the base station, based on the initial access signal transmitted by the plurality of UEs. The base station determines a number of subarrays to be allocated to each UE belonging to the first group UEs based on a number of streams for the first group UEs, and determines a number of subarrays to be allocated to each UE belonging to the second group UEs based on a propagation loss for the second group UEs. The base station allocates a subarray ID based on the determined number of subarrays, and allocates a subarray corresponding to the allocated subarray ID to each UE.

In step S2230, the base station transmits a training signal to each UE via one or more streams based on the subarray allocated to each UE.

In step S2240, each UE calculates a magnitude of a received signal for each stream based on the training signal transmitted from the base station.

In step S2250, each UE transmits a feedback signal comprising a Modulation and Coding Scheme (MCS) level to the base station.

In step S2260, the base station determines an MCS level for each stream of each UE.

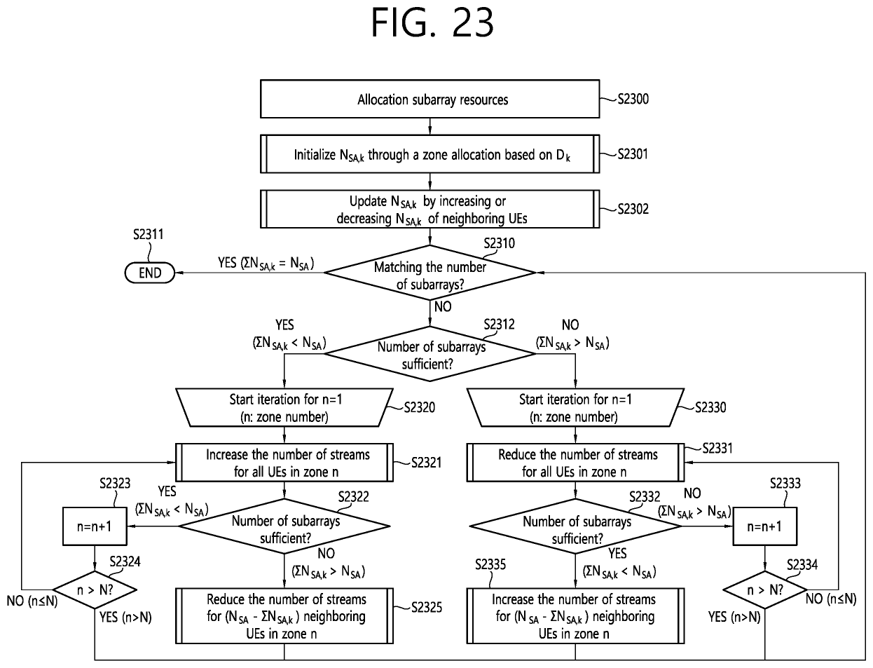

FIG. 23 shows an example of a method for determining the number of subarrays to be allocated to each UE to which implementations of the present disclosure are applied.

In steps S2300 through S2302, the base station allocates subarray resources. The operations of steps S1800 through S1802 described above in FIG. 18 may be performed.

In step S2310, the base station determines whether the total sum of N_{SA,k} matches the number of subarrays the base station has. In step S2311, the base station determines that the total sum of N_{SA,k} is equal to the number of subarrays the base station has, and the procedure ends.

In step S2312, the base station checks whether the number of subarrays is sufficient (i.e., whether the total sum of N_{SA,k} is less than the number of subarrays N_{SA} that the base station has).

If the number of subarrays is sufficient, the operation of (2)b) of step S1802 below in FIG. 18 may be performed. That is, the operation by the pseudocode of Equation 4 may be performed. More specifically, the following operations may be performed.
Step S2320: Iteration for n=1 is started (n: zone number).
Step S2321: Increase the number of streams for all UEs in zone n.
Step S2322: Check whether there are still enough subarrays (i.e., whether the total sum of N_{SA,k} is less than the number of subarrays N_{SA} that the base station has).
Step S2323: If the number of subarrays is still sufficient, increase n by 1.
Step S2324: Check whether n is greater than the number of zones N. If not, return to Step S2321 and perform the operation. If n>N, return to step S2310 and perform the operation.
Step S2325: If the number of subarrays is insufficient (i.e., the total sum of N_{SA,k} is greater than the number of subarrays N_{SA} that the base station has), reduce the number of streams for (N_{SA}−Σ_{NSA,k}) neighboring UEs in zone n.

If the number of subarrays is insufficient, operation (2)a) of step S1802 below in FIG. 18 may be performed. That is, an operation by the pseudocode of Equation 3 may be performed. More specifically, the following operations may be performed.
Step S2330: Iteration for n=1 is started (n: zone number).
Step S2331: The number of streams for all UEs in zone n is decremented.
Step S2332: Check whether the number of subarrays is sufficient (i.e., whether the total sum of N_{SA,k} is less than the number of subarrays N_{SA} that the base station has).
Step S2333: If the number of subarrays is still insufficient, increase n by 1.
Step S2334: Check whether n is greater than the number of zones N. If not, return to Step S2331 and perform the operation. If n>N, return to step S2310 and perform the operation.
Step S2335: If the number of subarrays is sufficient (i.e., the total sum of N_{SA,k} is less than the number of subarrays N_{SA} that the base station has), increase the number of streams for (N_{SA}−Σ_{NSA,k}) neighboring UEs in zone n.

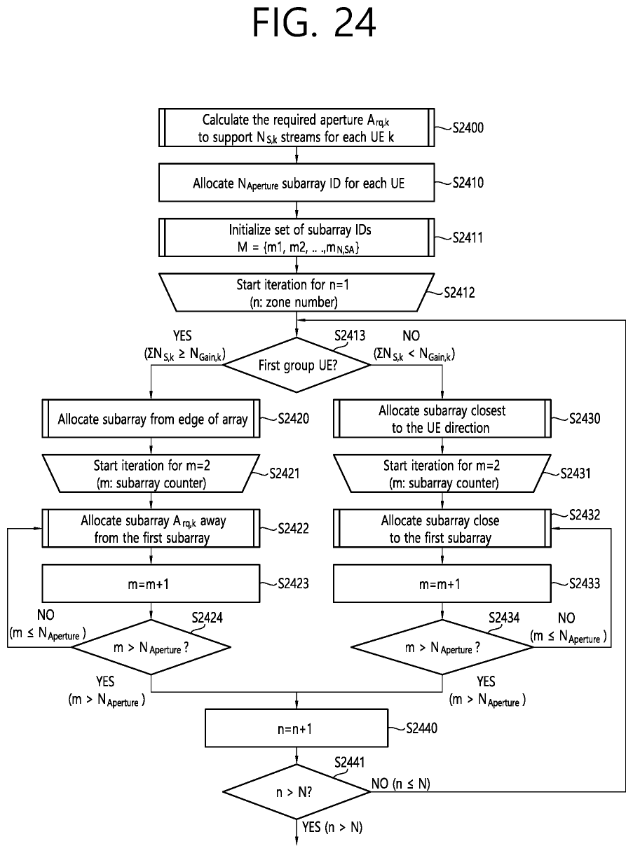

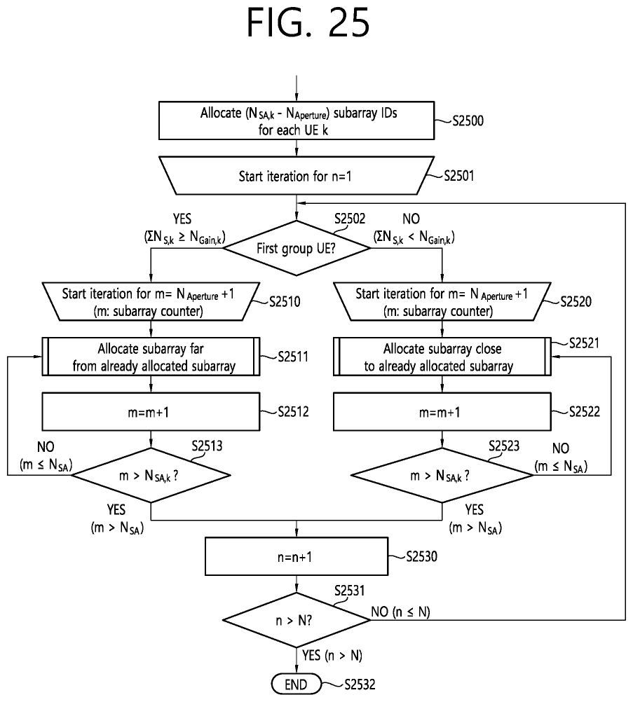

FIGS. 24 and 25 show an example of a method for allocating a subarray to each UE subject to which implementations of the present disclosure are applied.

The operations of FIGS. 24 and 25 may be performed subsequent to the operations described above in FIG. 23.

First, the operations of FIG. 24 will be described. The operation by the pseudocode of the above-described Equation 7 may be performed. More specifically, the following operations may be performed.

In step S2400, the base station calculates, for each UE k, a distance Dₖ from the base station and a required aperture A_{rq,k} to support N_{S,k} streams. The operation of step S1803 described above in FIG. 18 may be performed.

In steps S2410 through S2411, the base station allocates N_{Aperture} subarray ID for each UE, and initializes a set of subarray IDs M. In FIG. 18, the operations of steps S1810 through S1811 described above may be performed.

In step S2412, the base station starts iteration for n=1 (n: zone number).

In step S2413, the base station determines whether the UE belongs to the first group zone. That is, the base station determines whether the UE belongs to the near-field zone and/or the Fresnel region.

If the UE belongs to the first group zone, the operations of step S1820 and step S1821 described above in FIG. 18 may be performed. More specifically, the following operations may be performed.
Step S2420: Allocate a first subarray at an edge of the array.
Step S2421: Start iteration for m=2 (m: subarray counter).
Step S2422: Allocate a subarray A_{rq,k} away from the first subarray.
Step S2423: Increment m by 1.
Step S2424: Check if m>N_{Aperture}: if not, return to Step S2422 and perform the operation. If m>N_{Aperture}, go to step S2440, described below.

If the UE does not belong to the first group zone, the operations of step S1830 and step S1831 described above in FIG. 18 may be performed. More specifically, the following operations may be performed.
Step S2430: Allocate a first subarray which is the closest in the UE direction.
Step S2431: Start iteration for m=2 (m: subarray counter).
Step S2432: Allocate the subarray closest to the first subarray.
Step S2433: Increment m by 1.
Step S2434: Check if m>N_{Aperture}: if not, return to Step S2432 and perform the operation. If m>N_{Aperture}, go to Step S2440, described below:

In step S2440, increase n by 1.

In step S2441, check whether n is greater than the number of zones N. If not, return to Step S2413 and perform the operation. If n>N, perform the operation of FIG. 25 described below.

The operation of FIG. 25 will be described below. The operation of FIG. 25 may be performed after the operation described above in FIG. 24. The operation by the pseudocode of the above-described Equation 8 may be performed. More specifically, the following operations may be performed.

In step S2500, the base station further allocates (N_{SA,k}−N_{Aperture}) subarray IDs for each UE k. The operation of step S1840 described above in FIG. 18 may be performed.

In step S2501, the base station initiates an iteration for n=1 (n: zone number).

In step S2502, the base station determines whether the UE belongs to a type 1 zone. That is, the base station determines whether the UE belongs to a near-field zone and/or a Fresnel region.

If the UE belongs to the first group zone, the operations of step S1842 described above in FIG. 18 may be performed. More specifically, the following operations may be performed.
Step S2510: The base station starts iteration for m=N_{Aperture}+1 (m: subarray counter).
Step S2511: The base station allocates a subarray that is farther away from the already allocated subarray.
Step S2512: Increment m by 1.
Step S2513: Check if m>N_{SA,k}. If not, return to Step S2511 and perform the operation. If m>N_{SA,k}, go to step S2530, described below.

If the UE is not in the first group zone, the operation of step S1843 described above in FIG. 18 may be performed. More specifically, the following operations may be performed.
Step S2520: The base station starts iteration for m=N_{Aperture}+1 (m: subarray counter).
Step S2521: The base station allocates a subarray that is close to an already allocated subarray.
Step S2522: Increment m by 1.
Step S2523: Check if m>N_{SA,k}. If not, return to Step S2521 and perform the operation. If m>N_{SA,k}, go to step S2530, described below.

In step S2530, increase n by 1.

In step S2531, check whether n is greater than the number of zones N. If not, return to step S2502 and perform the operation. If n>N, the procedure terminates at step S2532.

The present disclosure can have various advantageous effects.

For example, in the terahertz band or sub-terahertz band, a subarray can be allocated to each user by considering the characteristics of the near and/or far users.

For example, the overall communication capacity of users served by a single base station can be increased.

For example, the same area can be served by fewer base stations, thereby reducing base station installation costs.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a base station in a wireless communication system, the method comprising:
performing an initial access with a plurality of User Equipment (UEs);
dividing the plurality of UEs into a first group UEs that are closer than a certain distance to the base station and a second group UEs that are further than a certain distance to the base station;
for the first group UEs, determining a number of subarrays to be allocated to each UE belonging to the first group UEs based on a number of streams;
for the second group UEs, determining a number of subarrays to be allocated to each UE belonging to the second group UEs based on a propagation loss;
allocating a subarray Identifier (ID) based on the determined number of subarrays;
allocating a subarray corresponding to the allocated subarray ID to each UE; and
communicating with each UE based on the subarray allocated to each UE.

2. The method of claim 1, wherein a distance between the base station and the plurality of UEs is determined based on an uplink access signal received from the plurality of UEs and/or a downlink training signal transmitted by the base station.

3. The method of claim 1, wherein determining the number of subarrays to be allocated to each UE belonging to the first group UEs and/or the number of subarrays to be allocated to each UE belonging to the second group UEs further comprises, updating the number of subarrays to be allocated to each UE belonging to the first group UEs and/or the number of subarrays to be allocated to each UE belonging to the second group UEs.

4. The method of claim 3, wherein the updating comprises, based on a sum of the number of subarrays to be allocated to each UE belonging to the first group UEs and the number of subarrays to be allocated to each UE belonging to the second group UEs being greater than a total number of subarrays of the base station, reducing the number of subarrays to be allocated to UEs belonging to the first group UEs in priority to the number of subarrays to be allocated to UEs belonging to the second group UEs.

5. The method of claim 3, wherein the updating comprises, based on a sum of the number of subarrays to be allocated to each UE belonging to the first group UEs and the number of subarrays to be allocated to each UE belonging to the second group UEs being less than a total number of subarrays of the base station, increasing the number of subarrays to be allocated to UEs belonging to the first group UEs in priority to the number of subarrays to be allocated to UEs belonging to the second group UEs.

6. The method of claim 1, further comprising calculating a required aperture, for each UE belonging to the first group UEs and for each UE belonging to the second group UEs.

7. The method of claim 6, wherein allocating the subarray ID based on the determined number of subarrays further comprises, allocating a reference subarray ID for each UE belonging to the first group UEs and for each UE belonging to the second group UEs.

8. The method of claim 7, wherein, for the first group UEs,
the reference subarray ID is a subarray ID at an edge based on a direction of each UE belonging to the first group UEs, and
a subarray corresponding to the reference subarray ID is a subarray having a largest angle between each UE belonging to the first group UEs.

9. The method of claim 7, wherein, for the second group UEs,
the reference subarray ID is a subarray ID closest to a direction of each UE based on the direction of each UE belonging to the second group UEs, and
a subarray corresponding to the reference subarray ID is a subarray having a smallest angle between each UE belonging to the second group UEs.

10. The method of claim 7, wherein allocating the subarray ID based on the determined number of subarrays further comprises,
for the first group UEs, allocating a first additional subarray ID distant from the reference subarray ID for the first group UEs by the required aperture for each UE; and
for the second group UEs, allocating a second additional subarray ID that is less distant from the reference subarray ID for the second group UEs.

11. The method of claim 10, wherein allocating the subarray ID based on the determined number of subarrays further comprises,
allocating a third additional subarray ID for the first group UEs and a fourth additional subarray ID for the second group UEs, based on the required aperture for each UE being greater than an aperture for each UE.

12. The method of claim 11, wherein the third additional subarray ID is allocated in priority to the fourth additional subarray ID.

13. The method of claim 11, wherein the third additional subarray ID is allocated such that a minimum value of a distance from the first additional subarray ID is greatest, and
wherein the fourth additional subarray ID is allocated such that a minimum value of a distance from the second additional subarray ID is smallest.

14-15. (canceled)

16. A base station adapted to operate in a wireless communication system, the base station comprising:
at least one transceiver including a plurality of subarrays;
at least one processor; and
at least one memory operably connectable to the at least one processor and storing instructions that, based on being executed by the at least one processor, perform operations comprising:
performing, via the at least one transceiver, an initial access with a plurality of User Equipment (UEs);
dividing the plurality of UEs into a first group UEs that are closer than a certain distance to the base station and a second group UEs that are further than a certain distance to the base station;
for the first group UEs, determining a number of subarrays to be allocated to each UE belonging to the first group UEs based on a number of streams;
for the second group UEs, determining a number of subarrays to be allocated to each UE belonging to the second group UEs based on a propagation loss;
allocating a subarray Identifier (ID) based on the determined number of subarrays;
allocating a subarray corresponding to the allocated subarray ID to each UE; and
communicating, via the at least one transceiver, with each UE based on the subarray allocated to each UE.

17. A User Equipment (UE) adapted to operate in a wireless communication system, the UE comprising:
at least one transceiver;
at least one processor; and
at least one memory operably connectable to the at least one processor and storing instructions that, based on being executed by the at least one processor, perform operations comprising:
performing, via the at least one transceiver, an initial access with a base station; and
communicating, via the at least one transceiver, with the base station based on a subarray allocated to the UE,
wherein the subarray corresponds to a subarray Identifier (ID) allocated based on a number of subarrays determined by the base station, and
wherein the number of subarrays is determined based on, i) a number of streams if a distance between the UE and the base station is closer than a certain distance, and ii) a propagation loss if a distance between the UE and the base station is farther than a certain distance.

18-19. (canceled)
